(19) United States
(12) Patent Application Publication
(10) Pub. No.: US 2024/0331015 A1
(43) Pub. Date: Oct. 3, 2024

(54) PREDICTIVE PICKING OF ITEMS FOR PREPOPULATING A SHOPPING CART FOR A SHOPPER

(71) Applicant: Maplebear Inc. (dba Instacart), San Francisco, CA (US)

(72) Inventors: Kenneth Jason Sanchez, Orange, CA (US); Eric Hermann, San Francisco, CA (US)

(21) Appl. No.: 18/129,464

(22) Filed: Mar. 31, 2023

(51) Int. Cl. G06Q 30/0601; G06Q 30/02

(52) U.S. Cl. CPC G06Q 30/0635; G06Q 30/0281; G06Q 30/0639

(57) ABSTRACT

An online concierge system facilitates creation of shopping lists of items for ordering from a physical retail store and at least partial self-service fulfillment of orders by the customer. To support fulfillment by the customer, the online concierge system may intelligently select one or more items of the order to be picked by a third-party picker and prepopulated to a shopping cart reserved for the customer in advance of the customer arriving at the retail location. The items for prepopulating may be selected based on various factors that optimize prepopulation decisions on an item-by-item basis in accordance with various machine learning models. The online concierge system may furthermore facilitate procurement of the remaining items by the customer through a customer client device that may track item procurement and/or provide guidance for locating items.

### BACKGROUND

This disclosure relates generally to an online concierge system for supporting a shopping experience of a customer.

An online concierge system includes an online application that supports a shopping experience of a shopper. The application enables a shopper to view items available at a particular retail store and add items to a virtual shopping list for in-store procurement, curbside delivery, or home delivery. In applications where the customer directly procures the items from the retail store, the application may support the shopper by guiding the shopper to the item locations in the retail store and tracking collection of the items from the shopping cart. In such a system, the amount of time it takes between a customer creating the shopping list and the customer successfully obtaining all of the desired items may be a significant factor in the customer's overall experience using the online concierge system. As such systems become increasingly prevalent, it may be important to reduce the amount taken to ultimately provide the desired items. Conversely, if a customer can pick some or all of the items more efficiently, the customer will have more time browsing elsewhere in the store to pick items where the customer's judgement may matter more.

### SUMMARY

In accordance with one or more aspects of the disclosure, an online concierge system facilitates creation of shopping lists of items. To support a self-service fulfillment by the customer, the online concierge system may intelligently select one or more items of the order to be picked by a third-party picker and prepopulated to a shopping cart reserved for the customer in advance of the customer arriving at the retail location. The items for prepopulating may be selected based on various factors that optimize the prepopulation decisions on an item-by-item basis in accordance with various machine learning models. The online concierge system may furthermore facilitate procurement of the remaining items by the customer (that are not prepopulated) through a customer client device that may track item procurement and/or provide guidance for locating items.

In one or more example embodiments, an online concierge system obtains, from a customer client device, a shopping list indicative of items selected by a customer and a pickup time selected by the customer for self-service fulfillment at a retail store. The online concierge system determines a subset of the items from the shopping list for prepopulating to a shopping cart reserved for the customer at the retail store. The subset of the items is identified from application of one or more machine learning models to score and rank the items in the shopping list in accordance with one or more scoring metrics. The online concierge system assigns one or more pickers to pick the subset of the items from shelf locations at the retail store and prepopulates the shopping cart reserved for the customer. The online concierge system facilitates picking of the subset of the items by the one or more pickers via a picker client device. The online concierge system furthermore facilitates, via the customer client device upon the customer arriving at the retail store, procurement of one or more remaining items from the shopping list that are absent from the subset of the items that are prepopulated to the shopping cart. The online concierge system facilitates a checkout process of the customer for the shopping list upon procurement of the one or more remaining items.

In one or more example embodiments, the online concierge system may determine one or more cost metrics associated with prepopulating respective candidate items to the shopping cart. In one or more embodiments, the cost metric may relate to respective incremental times for picking the respective candidate items. In one or more additional or alternative embodiments, the cost metric may relate to wages paid to pickers for picking the respective candidate items. In yet one or more additional or alternative embodiments, the cost metric may relate to opportunity costs associated with assigning picking tasks for the respective candidate items. The online concierge system determines the subset of the items for prepopulating to the shopping cart based at least in part on the one or more cost metrics for the respective candidate items.

In one or more example embodiments, the online concierge system determines one or more benefit metrics associated with prepopulating respective candidate items to the shopping cart. The benefit metrics are inferred from the application of the one or more machine learning models. The subset of the items may be determined based at least in part on the one or more benefit metrics for the respective candidate items.

In one or more example embodiments, the one or more benefit metrics may comprise an inferred incremental gain in purchases of sponsored items by the customer that can be attributed to selecting a candidate item for prepopulating to the shopping cart. In one or more additional or alternative example embodiments, the one or more benefit metrics may comprise an inferred incremental gain in purchases of items by the customer responsive to promotions or coupons that can be attributed to selecting a candidate item for prepopulating to the shopping cart. In yet one or more additional or alternative example embodiments, the one or more benefit metrics may comprise an inferred incremental gain in additional shopping time taken or additional items purchased by the customer that can be attributed to selecting a candidate item for prepopulating to the shopping cart. In yet one or more additional or alternative example embodiments, the one or more benefit metrics may comprise an inferred incremental gain in future purchases by the customer that can be attributed to selecting a candidate item for prepopulating to the shopping cart.

In one or more example embodiments, the one or more machine learning models are each trained to infer different benefit metrics based on an input decision of whether or not to include a candidate item for prepopulating to the shopping cart.

In one or more example embodiments, one or more machine learning models are each trained according to a learning process. A first historical dataset is obtained that includes a first value of a benefit metric resulting from an input prepopulation decision to include a candidate item in prepopulated shopping carts for a first population of customers. A second historical dataset is obtained that includes a second value of the benefit metric resulting from the input prepopulation decision to exclude the candidate item in prepopulated shopping carts for a second population of customers. The one or more machine learning models are trained to learn parameters for inferring differences between the first and second values of the benefit metric depending on the input prepopulation decision for the candidate item.

In one or more example embodiments, determining the subset of the items may include determining a promotional or replacement item to add to the shopping list as an additional item based on a likelihood of the additional item being accepted for purchase by the customer, and including the additional item in the subset of the items.

In another aspect, a non-transitory computer-readable storage medium stores instructions executable by one or more processors for performing any of the methods described above. In yet another aspect, a computer system includes one or more processors and a non-transitory computer-readable storage medium that stores instructions executable by the one or more processors for performing any of the methods described above.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a block diagram illustrating an example embodiment of a cart prepopulation module associated with an online concierge system.

FIG. 4 is a flowchart illustrating an example embodiment of a process for prepopulating shopping carts for customers of an online concierge system.

### DETAILED DESCRIPTION

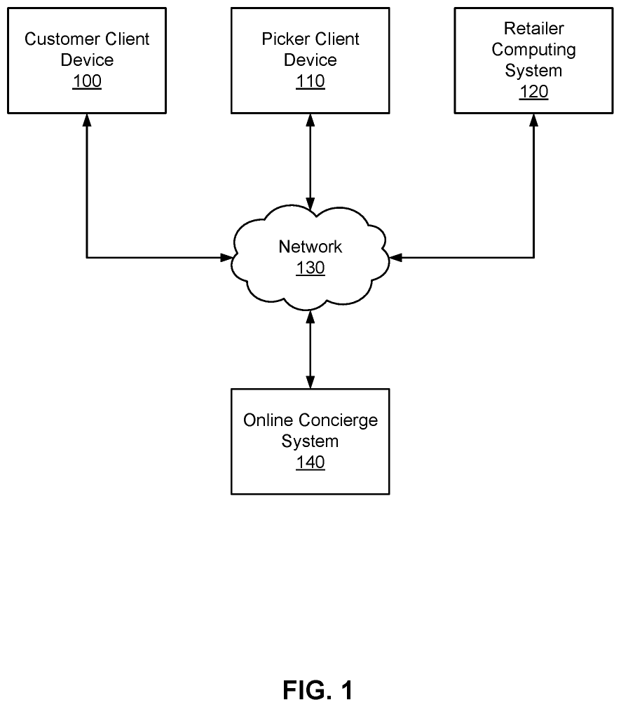

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The online concierge system 140 is an online system by which customers can create a shopping list and order items from a retailer. The online concierge system 140 may enable orders to be fulfilled by a third-party picker for curbside or home delivery or may enable a customer to fulfill orders wholly or partially through self-service procurement of the items at the retailer. In the self-service example, the online concierge system 140 may facilitate intelligent selection of items to be picked by a third party and prepopulated to a shopping cart reserved for the customer in advance of the customer arriving at the retail store. The items for prepopulating may be selected based on various factors that optimize prepopulation decisions on an item-by-item basis.

In an example customer experience, the online concierge system 140 receives a shopping list for a customer using a customer client device 100. The shopping list may relate to, for example, a set of groceries for self-service pickup from a grocery store retailer. The customer's order may specify which groceries they want from the grocery store, the quantities of each of the groceries, and a pick-up time. When the customer arrives at the store, the customer client device 100 may send a push notification directing the customer to a location of a partially prepopulated cart inside the store entrance that is reserved for the customer. For example, the client device 100 may show the location on a map of the store and/or provide navigational guidance to the location. Furthermore, the cart may include a digital sign with the customer's name on it or another identifier (e.g., an order number). At least some of the items from the shopping list may have already been prepopulated into the customer's cart, but some of the items may be missing from the cart and left for the customer to locate. In some embodiments, the prepopulated items may be limited to shelf-stable items that do not require refrigeration or freezing. While the customer shops for the remaining items, the customer client device 100 may display a map of the store with locations of the remaining items in the shopping list and/or wayfinding instructions. Furthermore, the customer client device 100 may present various coupons and/or recommendations associated with additional items that may be of interest to the customer. When the customer is done shopping, the customer client device 100 may optionally facilitate a rapid checkout process. The described shopping experience may be particularly desirable for customers who enjoy the experience of shopping in a physical retail store while still appreciating some of the conveniences of online ordering. The experience may furthermore provide a steppingstone and thereby convert additional customers to a full service shopping and delivery experience.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be obtained by the customer based on one or more possible procurement methods. Under a self-service method, the customer may directly procure the items in the order from the physical retail store. In this technique, the same individual may fulfill the role of customer and picker. Under a delivery method, a third-party shopper may procure items and deliver them to the customer via curbside or home delivery. As will be further described herein, various hybrid techniques may be employed in which some items of an order are pre-picked for a customer to prepopulate in a shopping cart prior to the customer arriving at the retail location, while other items may be left for the customer to pick from their shelf locations. An “item,” as used herein, may include a good or product that can be provided to the customer through the online concierge system 140. The order may include item identifiers (e.g., a stock keeping unit or a price look-up code) for items to be obtained by the user and may include quantities of the items. Additionally, an order may further include a procurement method (e.g., self-service or delivery) and a timeframe during which the items should be fulfilled. In some embodiments, the order also specifies one or more retailers from which the ordered items will be obtained.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

The customer client device 100 may include a communication interface that allows the customer to communicate with a picker that is servicing the customer's order (which may, e.g., be useful if a third party picker is used for an order, for instance, to fully fulfill orders or to partially prepopulate a cart). This communication interface allows the user to input a text-based message to transmit to the picker client device 110 via the network 130. The picker client device 110 receives the message from the customer client device 100 and presents the message to the picker. The communication interface of the picker client device 110 also allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives instructions from the online concierge system 140 to enable pickers to facilitate orders. In some cases, a picker may service an individual order in its entirety by collecting the items listed in the order from a retailer. In other cases, a picker may service a portion of an order by picking individual items to prepopulate in a cart for a customer that will fulfill the rest of the order. The picker client device 110 may present items to the picker for picking in a collection interface. The collection interface may be one or more graphical user interfaces that provide information to the picker on which items to collect for orders from one or more customers and the quantities of the items. In some embodiments, the collection interface provides items from multiple orders from multiple different customers for the picker to service at the same time from the same retailer location. The collection interface further presents instructions that one or more customers may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items assigned for picking. The picker client device 110 may include a barcode scanner that can determine an item identifier encoded in a barcode coupled to an item. The picker client device 110 compares this item identifier to items assigned to the picker, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

For orders that are assigned for delivery by a picker, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

If a picker is assigned to pick items for partially prepopulating carts for one or more customers, the delivery location associated with the picking assignment may be a staging location within the retail store. When a customer arrives at the retail store, the customer may be directed to a specific cart associated with their order (which may include one or more prepopulated items).

In one or more embodiments, the picker for an order is a single person who collects items for an order from a retailer location. Alternatively, more than one person may serve the role as a picker for an order. For example, multiple people may collect the items at the retailer location for a single order and each individually may concurrently operate to pick items for multiple orders. For delivery orders, the deliverer may be the same picker that picked the items or a different individual. In these embodiments, each person may have a picker client device 110 that they can use to interact with the online concierge system 140. When the customer is picking items that have not been prepopulated, the customer may operate as the picker and may be presented with various features in the customer client device 100 for locating items and tracking procurement similar to the features available in the picker client device 110.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

In one implementation variation, the customer client device 100 may execute two or more different applications that each enable different procurement methods. For example, one application may be designed specifically for self-service shopping cart creation, while another separate application may be utilized for full-service delivery orders. The applications may optionally be linked to use at least some overlapping backend architecture to facilitate various processes described herein. In other implementations, a single application may enable customer selection between different procurement methods.

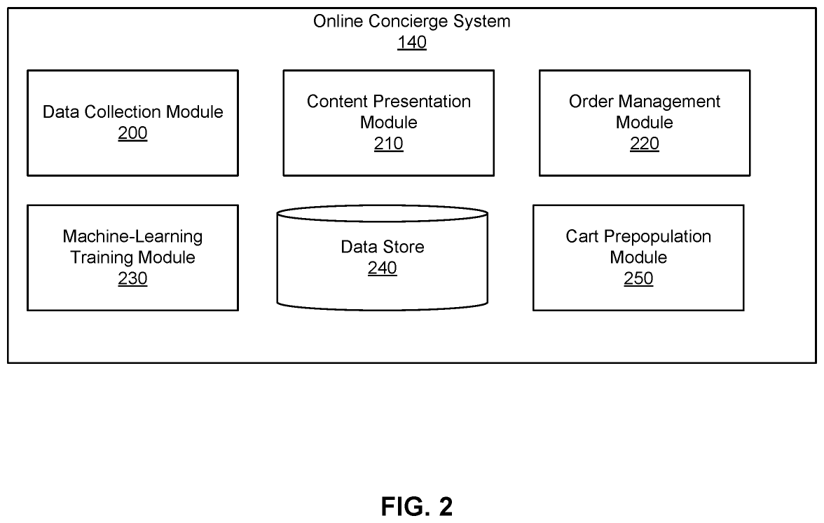

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, a data store 240, and a cart prepopulation module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location or timeframe for delivery orders, and preferences associated with cart prepopulation for self-service orders. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm, a large language model, and/or by other means).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a procurement method for the order, a customer associated with the order, a retailer location for the order, or a timeframe for order fulfillment (either via delivery or self-service). Order data may further include information describing how the order was serviced, such as which picker serviced the order, if the order was delivered or procured by the customer, which items, if any, were prepopulated to a cart for the customer, or a rating that the customer gave the delivery of the order.

The content presentation module 210 selects content for presentation to a customer. For example, the content presentation module 210 selects which items to present to a customer while the customer is creating an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100. For delivery orders, the order management module 220 may assign orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

For delivery orders, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

For self-service orders, the order management module 220 may instead facilitate assignments of individual items to pickers for the purpose of at least partially prepopulating shopping carts for self-service customers. Here, picker assignments may similarly be on picker location, availability, or other metrics as described in further detail below. The order management module 220 may also facilitate instructions to the picker to direct the picker to locations of items associated with the assignments and direct the picker to cart for prepopulating with the picked items.

As the picker uses the picker client device 110 to collect items at the retailer location for cart prepopulation, the order management module 220 may receive item identifiers for items that the picker has collected. In some embodiments, the order management module 220 receives images of items from the picker client device 110 and applies computer-vision techniques to the images to identify the items depicted by the images. The order management module 220 may track the progress of the picker as the picker collects items for a cart prepopulation assignment and may transmit information to one or more customer client devices 100 that describe which items have been collected and prepopulated in the carts.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order. Tracking of items may be facilitated using a smart cart with integrated cameras, scanners, and/or other sensors to automatically track items added to the cart.

The order management module 220 determines when the picker has collected all of the items associated with a particular assignment. For example, the order management module 220 may receive a message from the picker client device 110 indicating that all of the items for an order have been collected. Alternatively, the order management module 220 may receive item identifiers for items collected by the picker and determine when all of the items in an order have been collected.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, Naïve Bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example May include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

While the machine learning training module 230 is illustrated as a separate module in FIG. 2, its features described herein may be incorporated into various other functional modules that employ machine learning elements as described above.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

The cart prepopulation module 250 facilitates predictive picking of items for at least partially prepopulating shopping carts for customers associated with self-service orders. The cart prepopulation module 250 may apply an optimization model that determines which items to prepopulate for different orders and how to assign those picking tasks to pickers. Here, the assignment is not necessarily one order per picker, and it may instead by assigned on an item-by-item basis for a group of orders from multiple different customers. For example, if there are multiple orders for the same item in an upcoming time window, it may be most efficient to assign one picker to pick a batch of the item for all orders and distribute the batch to the various shopping carts. Similarly, pickers may be assigned to specific zones of a retail store to pick items in that zone which may span multiple orders for different customers. The pickers may then bring the items to a staging area where the reserved carts are located and populate the items to the respective carts.

In one or more embodiments, the cart prepopulation module 250 may select items to add to a shopping list and/or prepopulate to a cart that are not necessarily included in the customer's original order. For example, if an ordered item is unavailable, the cart prepopulation module 250 may infer that the customer may want a replacement item and may generate an assignment to prepopulate the cart with the replacement item. In one or more additional or alternative embodiments, the cart prepopulation module 250 may assign a picker to add a promotional item to a customer's cart that the cart prepopulation module 250 predicts may be of interest to a customer.

The cart prepopulation module 250 may determine which items to prepopulate in carts based in part on a characterization of an incremental cost (in dollars, time, other metric, or a combination thereof) associated with a picker retrieving the item from its shelf location and an incremental benefit derived from that item being prepopulated to the customer's cart as further described below.

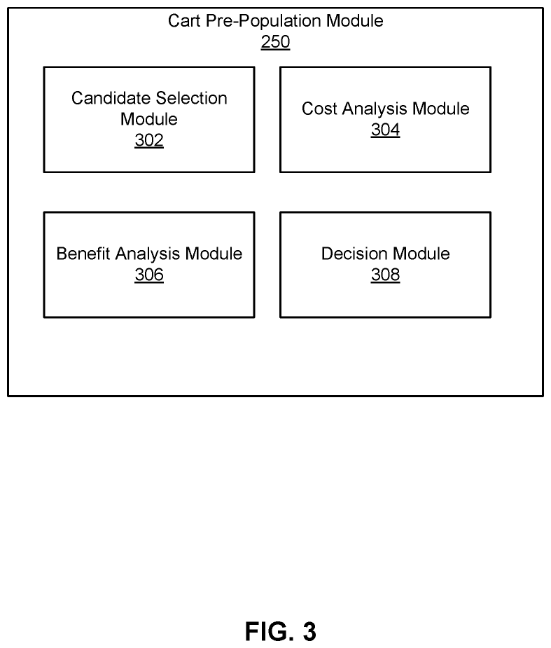

FIG. 3 illustrates an example embodiment of a cart prepopulation module 250. In the example embodiment, the cart prepopulation module 250 includes a candidate selection module 302, a cost analysis module 304, a benefit analysis module 306, and a decision module 308. Various alternative embodiments may include different or additional elements.

The candidate selection module 302 selects a set of candidate items for analyzing for possible prepopulation to a shopping cart. The candidate items may include a filtered subset of items from the shopping list that may be filtered based on various criteria. For example, items that are not shelf stable may be excluded from the set of candidate items to avoid spoliation. Furthermore, items that are determined to be unavailable (e.g., out of stock) may be automatically excluded. The candidate selection module 302 may furthermore optionally add one or more items to the shopping list and candidate list that it infers may be of interest to the customer. For example, the candidate selection module 302 may add a replacement item for unavailable items, may add certain promotional items, and/or may add items for which coupons are available. In one or more embodiments, addition of items outside of the customer's original shopping list may be subject to preconfigured customer preferences.

The cost analysis module 304 computes one or more cost metrics associated with prepopulating an individual item to a shopping cart reserved for a self-service customer. The cost metrics may be based on time, dollar expenditures (e.g., wages), opportunity costs, or other factors. The time associated with picking an item may be based on an incremental time for a picker to pick the item given other picking assignments. The incremental time may therefore depend in part on collective set of items being ordered (for multiple customers) in a given time period. For example, if multiple customers order the same item or items stocked to the same zone of the store, the incremental additional time to pick one more of that item is relatively small. On the other hand, if an item appears in only one order and is in a different zone from other ordered items, the incremental time may be relatively high since a picker would have to go out of the way to get the item.

In one or more embodiments, a picking time used to compute the cost metric may be derived in part from a store plan (e.g., in the form of a map and/or data table) associated with the retailer location that includes information about the storage location of each item and/or the relative distances and/or paths to the staging area for prepopulating carts. Additionally or alternatively, a path modeling algorithm may be employed to predict the time associated with picking an item to prepopulate a cart. Here, the path modeling algorithm may predict the paths through the retail environment associated with a picking task for an item based on an expected baseline path for a picker. For example, the total time for picking two items when one item is along the predicted path to a second item may be significantly less than the sum of the times for different pickers to pick the same two items. In one or more embodiments, the path modeling algorithm may be based on historical tracking data from tracking pickers through the retail location during historical order fulfillments. The tracking data may be obtained, for example, from a location service of the picker client device 110, a smart shopping cart that tracks location, in-store sensors, camera, or other location tracking techniques.

The cost metric may furthermore be based in part on an opportunity cost associated with available pickers and other assignable tasks for those pickers. For example, if a salaried employee is available to pick the items and is not busy with other tasks, the opportunity cost may be zero or negligible to assign the employee to the picking tasks. On the other hand, if an employee would be taken away from other valuable tasks (which could be other picking tasks or various store responsibilities), there is an opportunity cost associated with forgoing the alternative task in favor of the picking task. Furthermore, if an hourly contractor is used to perform picking tasks, the cost per item may be based on the wages paid to the contractor to perform the task.

The benefit analysis module 306 computes one or more benefit metrics associated with picking an item for prepopulating in a cart of a customer. In an embodiment, the benefit metric may relate to an inferred improvement in the likelihood, frequency, or other measurable parameter (or combination thereof) at which a customer purchases sponsored items that can be attributed to including the item in a prepopulated cart. The benefit may be directly attributable for items added as promotional items that were absent from the customer's original shopping list. Additionally or alternatively, indirect benefit may be achieved because of a customer's increased usage of the online concierge system 140 and attention to promotions attributable to a positive customer experience. The benefit metric may furthermore relate to an inferred improvement in the likelihood, frequency, or other measurable parameter (or combination thereof) at which a customer purchases an additional item based on a presented advertisement or coupon attributable to the item being prepopulated to the shopping cart. The benefit metric may furthermore relate to an inferred additional amount of time a customer may spend shopping (and may therefore be more likely to make additional purchases) that can be attributable to time the saved from prepopulating an item to cart. The benefit metric may furthermore relate to an inferred additional quantity or dollar value of additional purchases the shopper makes in the future that is attributable to the incremental improvement in the customer's experience based on the item being prepopulated to the cart. Various benefit sub-metrics based on various factors may be combined based on one or more aggregation functions.

In one or more embodiments, the benefit analysis module 306 may derive different components of the benefit metric from one or more machine learning models that predict the change in value of the benefit metric based on whether or not a particular item is prepopulated to a customer's cart. The one or more machine learning models may be trained based on historical data associated with instances where items are prepopulated and instances where the items are not prepopulated, and respective outcomes in the different instances. In one or more embodiments, the machine learning models may comprise uplift models that employ a causal learning approach to estimate the effects of various prepopulation decisions.

In order to generate historical data that is well-suited to train such models, the benefit analysis module 306 may employ an experiment-based approach in which items are prepopulated to carts of some customers and not to others. Here, the decision may be based in part on a randomization function to create contrasting situations that provide strong data for comparison. The input decisions of whether or not to prepopulate certain items to carts and the resulting benefit metrics may then be used as labels to train supervised learning models capable of predicting the benefit metrics dependent on the input decisions.

The decision module 308 may combine the respective cost metrics and the benefit metrics for each item to determine whether or not to assign the item to a picker for prepopulating to the customer's shopping cart. The decision module 308 may generate scores (based on the respective cost and benefit metrics) for respective candidate items on a per-item basis for a customer and generate a ranked list of the candidate items. The decision module 308 may then apply various cutoff techniques to determine which items from the ranked list to prepopulate for the customer. For example, the decision module 308 may determine the cutoff based on a score threshold, based on the number of items (e.g., prepopulate the top n items), or another technique. The candidate items for ranking may include the items in the customer's order, but may also include various replacement and/or promotional items as discussed above.

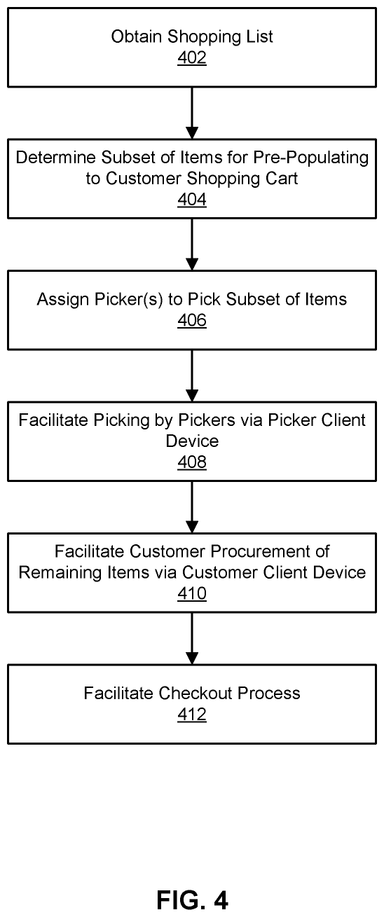

FIG. 4 is a flowchart illustrating a method for facilitating prepopulation of a shopping cart for an order set for at least partial self-fulfillment by a customer. Alternative embodiments may include more, fewer, or different steps from those illustrated in FIG. 4, and the steps may be performed in a different order from that illustrated in FIG. 4. These steps may be performed by an online concierge system (e.g., online concierge system 140). Additionally, each of these steps may be performed automatically by the online concierge system without human intervention.

The online concierge system 140 obtains 402, from the customer client device 100, a shopping list indicative of items selected by a customer for at least partial self-service fulfillment. The shopping list may include a desired pickup time selected by the customer. Prior to the pickup time, the online concierge system 140 determines 404 a subset of the items from the shopping list for prepopulating to a shopping cart reserved for the customer at the retail store. The selection of items may be based in part on application of a machine learning model that scores and rank the items in the shopping list in accordance with one or more scoring metrics (e.g., a cost metric, a benefit metric, or a combination thereof). For example, the online concierge system 140 may select items that maximize a net benefit relative to cost. The benefit may be based on various factors such as the incremental value or uplift in revenue from promotions, purchases of items on the shopping list or additional items, long term sales increases, or other factors that are observed or inferred to be attributable to prepopulation of the item for the customer. The online concierge system 140 may train the models in an offline manner and/or an online manner based on historical data from smart shopping carts that track movement of customers and/or pickers through the retail and track items added to the cart. In an embodiment, the online concierge system 140 may send information to the customer client device 100 to notify the customer of the items that will be prepopulated.

The online concierge system 140 assigns 406 one or more pickers to pick the subset of items selected for prepopulation from shelf locations at the retail store. Here, a zone picking technique may be used in which different pickers may be assigned to pick items from different zones of a retail store which may span multiple orders from different customers with similar pickup times. The assignments may be optimized based on various path planning models to enable efficient picking of items by the pickers.

The online concierge system 140 may facilitate 408 picking of the items by the pickers via the picker client devices 110. For example, the online concierge system 140 may send instructions to the respective picker client devices 110 indicative of the items to be picked, their locations in the retail store, and the shopping carts where the items should be prepopulated.

Upon the customer's arrival at the retail store, the online concierge system 140 may further facilitate 410, via the customer client device 100 procurement of remaining items from the customer's shopping list that are absent from the subset of the items that are prepopulated to the shopping cart. For example, the online concierge system 140 may provide instructions indicative of the items left to be picked, their locations in the retail stores, and/or recommend paths to most efficiently obtain the items. The online concierge system 140 may furthermore send notifications to the customer client device 100 indicative of other items that are not in the shopping list but may be of interest to the customer such as promotional items, items with available coupons, and replacement items for items in the shopping list that are unavailable. The online concierge system 140 may furthermore facilitate tracking of items that have been procured. Tracking may be achieved using a smart shopping cart device that has integrated cameras, scanners, or other sensors to detect items added to the shopping cart.

Upon finalizing shopping, the online concierge system 140 may facilitate 412 a checkout process of the customer for the shopping list and any additional items that the customer added during the shopping experience. For example, online concierge system 140 may facilitate 412 the checkout process by processing an electronic payment associated with an account of the customer, and it may further enable the customer to bypass a standard in-store checkout process.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising, at a computer system comprising a processor and a computer-readable medium:
obtaining, by an online concierge system from a customer client device, a shopping list that contains one or more items selected by a customer and a pickup time selected by the customer for self-service fulfillment at a retail store;
determining, by the online concierge system, a subset of the items from the shopping list for prepopulating to a shopping cart reserved for the customer at the retail store, wherein the subset of the items is identified from application of one or more machine learning models to score and rank the items in the shopping list in accordance with one or more scoring metrics;
assigning, by the online concierge system, one or more pickers to pick the subset of the items from shelf locations at the retail store and prepopulate the shopping cart reserved for the customer;
causing a picker client device associated with each of the assigned one or more pickers to display the subset of the items to facilitate picking thereof by the one or more pickers;
causing the customer client device, upon the customer arriving at the retail store, to display information about one or more remaining items from the shopping list that are absent from the subset of the items that are prepopulated to the shopping cart, to facilitate procurement thereof by the customer; and
logging information about a checkout process conducted by the customer at the retail store for the items on the shopping list.

2. The method of claim 1, wherein determining the subset of the items from the shopping list for prepopulating to the shopping cart reserved for the customer comprises:
determining one or more cost metrics associated with prepopulating respective candidate items to the shopping cart, wherein the cost metrics relate to at least one of: respective incremental times for picking the respective candidate items, wages paid to pickers for picking the respective candidate items, and respective opportunity costs associated with assigning picking tasks for the respective candidate items; and
determining the subset of the items based at least in part on the one or more cost metrics for the respective candidate items.

3. The method of claim 1, wherein determining the subset of the items from the shopping list for prepopulating to the shopping cart reserved from the customer comprises:
determining one or more benefit metrics associated with prepopulating respective candidate items to the shopping cart, wherein the benefit metrics are inferred from the application of the one or more machine learning models; and
determining the subset of the items based at least in part on the one or more benefit metrics for the respective candidate items.

4. The method of claim 3, wherein the one or more benefit metrics comprises at least one of:
an inferred incremental gain in purchases of sponsored items by the customer that can be attributed to selecting a candidate item for prepopulating to the shopping cart;
an inferred incremental gain in purchases of items by the customer responsive to promotions or coupons that can be attributed to selecting a candidate item for prepopulating to the shopping cart;
an inferred incremental gain in additional shopping time taken or additional items purchased by the customer that can be attributed to selecting a candidate item for prepopulating to the shopping cart; and
an inferred incremental gain in future purchases by the customer that can be attributed to selecting a candidate item for prepopulating to the shopping cart.

5. The method of claim 3, wherein the one or more machine learning models are each trained to infer different benefit metrics based on an input decision of whether or not to include a candidate item for prepopulating to the shopping cart.

6. The method of claim 1, wherein the one or more machine learning models are each trained according a learning process comprising:
obtaining a first historical dataset including a first value of a benefit metric resulting from an input prepopulation decision to include a candidate item in prepopulated shopping carts for a first population of customers;
obtaining a second historical dataset including a second value of the benefit metric resulting from the input prepopulation decision to exclude the candidate item in prepopulated shopping carts for a second population of customers; and
training the one or more machine learning models to learn parameters for inferring differences between the first and second values of the benefit metric depending on the input prepopulation decision for the candidate item.

7. The method of claim 1, wherein determining the subset of the items comprises:
determining a promotional or replacement item to add to the shopping list as an additional item based on a likelihood of the additional item being accepted for purchase by the customer; and
including the additional item in the subset of the items.

8. A non-transitory computer-readable storage medium storing instructions executable by one or more processors for performing steps including:
obtaining, by an online concierge system from a customer client device, a shopping list that contains one or more items selected by a customer and a pickup time selected by the customer for self-service fulfillment at a retail store;
determining, by the online concierge system, a subset of the items from the shopping list for prepopulating to a shopping cart reserved for the customer at the retail store, wherein the subset of the items is identified from application of one or more machine learning models to score and rank the items in the shopping list in accordance with one or more scoring metrics;
assigning, by the online concierge system, one or more pickers to pick the subset of the items from shelf locations at the retail store and prepopulate the shopping cart reserved for the customer;
causing a picker client device associated with each of the assigned one or more pickers to display the subset of the items to facilitate picking thereof by the one or more pickers;
causing the customer client device, upon the customer arriving at the retail store, to display information about one or more remaining items from the shopping list that are absent from the subset of the items that are prepopulated to the shopping cart, to facilitate procurement thereof by the customer; and
logging information about a checkout process conducted by the customer at the retail store for the items on the shopping list.

9. The non-transitory computer-readable storage medium of claim 8, wherein determining the subset of the items from the shopping list for prepopulating to the shopping cart reserved for the customer comprises:
determining one or more cost metrics associated with prepopulating respective candidate items to the shopping cart, wherein the cost metrics relate to at least one of: respective incremental times for picking the respective candidate items, wages paid to pickers for picking the respective candidate items, and respective opportunity costs associated with assigning picking tasks for the respective candidate items; and
determining the subset of the items based at least in part on the one or more cost metrics for the respective candidate items.

10. The non-transitory computer-readable storage medium of claim 8, wherein determining the subset of the items from the shopping list for prepopulating to the shopping cart reserved from the customer comprises:
determining one or more benefit metrics associated with prepopulating respective candidate items to the shopping cart, wherein the benefit metrics are inferred from the application of the one or more machine learning models; and
determining the subset of the items based at least in part on the one or more benefit metrics for the respective candidate items.

11. The non-transitory computer-readable storage medium of claim 10, wherein the one or more benefit metrics comprises at least one of:
an inferred incremental gain in purchases of sponsored items by the customer that can be attributed to selecting a candidate item for prepopulating to the shopping cart;
an inferred incremental gain in purchases of items by the customer responsive to promotions or coupons that can be attributed to selecting a candidate item for prepopulating to the shopping cart;
an inferred incremental gain in additional shopping time taken or additional items purchased by the customer that can be attributed to selecting a candidate item for prepopulating to the shopping cart; and
an inferred incremental gain in future purchases by the customer that can be attributed to selecting a candidate item for prepopulating to the shopping cart.

12. The non-transitory computer-readable storage medium of claim 10, wherein the one or more machine learning models are each trained to infer different benefit metrics based on an input decision of whether or not to include a candidate item for prepopulating to the shopping cart.

13. The non-transitory computer-readable storage medium of claim 8, wherein the one or more machine learning models are each trained according a learning process comprising:
obtaining a first historical dataset including a first value of a benefit metric resulting from an input prepopulation decision to include a candidate item in prepopulated shopping carts for a first population of customers;
obtaining a second historical dataset including a second value of the benefit metric resulting from the input prepopulation decision to exclude the candidate item in prepopulated shopping carts for a second population of customers; and
training the one or more machine learning models to learn parameters for inferring differences between the first and second values of the benefit metric depending on the input prepopulation decision for the candidate item.

14. The non-transitory computer-readable storage medium of claim 8, wherein determining the subset of the items comprises:
determining a promotional or replacement item to add to the shopping list as an additional item based on a likelihood of the additional item being accepted for purchase by the customer; and
including the additional item in the subset of the items.

15. A computer system comprising:
one or more processors; and
a non-transitory computer-readable storage medium storing instructions executable by the one or more processors for performing steps including:
obtaining, by an online concierge system from a customer client device, a shopping list that contains one or more items selected by a customer and a pickup time selected by the customer for self-service fulfillment at a retail store;
determining, by the online concierge system, a subset of the items from the shopping list for prepopulating to a shopping cart reserved for the customer at the retail store, wherein the subset of the items is identified from application of one or more machine learning models to score and rank the items in the shopping list in accordance with one or more scoring metrics;
assigning, by the online concierge system, one or more pickers to pick the subset of the items from shelf locations at the retail store and prepopulate the shopping cart reserved for the customer;
causing a picker client device associated with each of the assigned one or more pickers to display the subset of the items to facilitate picking thereof by the one or more pickers;
causing the customer client device, upon the customer arriving at the retail store, to display information about one or more remaining items from the shopping list that are absent from the subset of the items that are prepopulated to the shopping cart, to facilitate procurement thereof by the customer; and
logging information about a checkout process conducted by the customer at the retail store for the items on the shopping list.

16. The computer system of claim 15, wherein determining the subset of the items from the shopping list for prepopulating to the shopping cart reserved for the customer comprises:
determining one or more cost metrics associated with prepopulating respective candidate items to the shopping cart, wherein the cost metrics relate to at least one of: respective incremental times for picking the respective candidate items, wages paid to pickers for picking the respective candidate items, and respective opportunity costs associated with assigning picking tasks for the respective candidate items; and
determining the subset of the items based at least in part on the one or more cost metrics for the respective candidate items.

17. The computer system of claim 15, wherein determining the subset of the items from the shopping list for prepopulating to the shopping cart reserved from the customer comprises:
determining one or more benefit metrics associated with prepopulating respective candidate items to the shopping cart, wherein the benefit metrics are inferred from the application of the one or more machine learning models; and
determining the subset of the items based at least in part on the one or more benefit metrics for the respective candidate items.

18. The computer system of claim 17, wherein the one or more benefit metrics comprises at least one of:
an inferred incremental gain in purchases of sponsored items by the customer that can be attributed to selecting a candidate item for prepopulating to the shopping cart;
an inferred incremental gain in purchases of items by the customer responsive to promotions or coupons that can be attributed to selecting a candidate item for prepopulating to the shopping cart;
an inferred incremental gain in additional shopping time taken or additional items purchased by the customer that can be attributed to selecting a candidate item for prepopulating to the shopping cart; and
an inferred incremental gain in future purchases by the customer that can be attributed to selecting a candidate item for prepopulating to the shopping cart.

19. The computer system of claim 17, wherein the one or more machine learning models are each trained to infer different benefit metrics based on an input decision of whether or not to include a candidate item for prepopulating to the shopping cart.

20. The computer system of claim 15, wherein the one or more machine learning models are each trained according a learning process comprising:
obtaining a first historical dataset including a first value of a benefit metric resulting from an input prepopulation decision to include a candidate item in prepopulated shopping carts for a first population of customers;
obtaining a second historical dataset including a second value of the benefit metric resulting from the input prepopulation decision to exclude the candidate item in prepopulated shopping carts for a second population of customers; and
training the one or more machine learning models to learn parameters for inferring differences between the first and second values of the benefit metric depending on the input prepopulation decision for the candidate item.
